(19) United States
(12) Patent Application Publication
(10) Pub. No.: US 2020/0104023 A1
(43) Pub. Date: Apr. 2, 2020

(54) ELECTRONIC DEVICE, TEXT PROCESSING METHOD, AND PROGRAM-STORING STORAGE MEDIUM

(71) Applicant: CASIO COMPUTER CO., LTD., Tokyo (JP)

(72) Inventor: Kohei Yoshida, Hanno-shi (JP)

(21) Appl. No.: 16/572,198

(22) Filed: Sep. 16, 2019

(30) Foreign Application Priority Data
Oct. 2, 2018 (JP) 2018-187606

(51) Int. Cl. G06F 3/0486; G06F 3/0485; G06F 3/0488; G06F 17/21

(52) U.S. Cl. CPC G06F 3/0486; G06F 17/211; G06F 3/04883; G06F 3/0485

(57) ABSTRACT

An electronic device includes a processor. The processor sets a start position of a drag operation on a text-displaying display, as a reference position for processing of a displayed text, and then performs a first operation including selecting, when the position of the drag operation has moved to a first relative position relative to the reference position, a character range in the text according to the drag operation, and setting, when the position of the drag operation has moved to a second relative position relative to the reference position, this second position as the new reference position.

### CROSS-REFERENCE TO RELATED APPLICATIONS

This application is based upon and claims the benefit of priority from prior Japanese Patent Application No. 2018-187606, filed Oct. 2, 2018, the entire contents of which are incorporated herein by reference.

### BACKGROUND OF THE INVENTION

### 1. Field of the Invention

The present invention relates to an electronic device adapted to perform processing for displayed texts.

### 2. Description of the Related Art

There have been a number of techniques offered, by which while texts are displayed on a touch panel-equipped display of an electronic device, selection of a text range is enabled according to positions on the text-displaying screen as specified by a stylus pen or a finger.

For example, when a screen is displaying a horizontal text string, a user specifies the first character of the text desired to be selected, and moves the specified position from the first character toward the right direction along the adjacent character string. In response to this action, the character string corresponding to the movement of the specified position is distinctly shown as a selected range of the text by highlighted display, etc. (e.g., Jpn. Pat. Appln. KOKAI Publication No. 2010-152500).

### SUMMARY

According to an aspect of the invention, an electronic device includes a display and a processor. The processor is adapted to set, in response to a start of a drag operation on the display when displaying a text, a position of the drag operation as a reference position for processing for the text, and to perform a first operation. The first operation includes an operation to select, in response to the position of the drag operation having moved to a first position at a first relative position relative to the reference position, a character range in the text according to the movement of the position of the drag operation, and an operation to set, in response to the position of the drag operation having moved to a second position at a second relative position relative to the reference position and different from the first relative position, the second position as the reference position afresh.

According to an aspect of the invention, an electronic device includes a display and a processor. The processor is adapted to set, in response to a start of a drag operation on the display when displaying a text, a position of the drag operation as a reference position, and to perform a first operation. The first operation includes an operation to select, in response to the position of the drag operation having moved to a first position at a first relative position relative to the reference position, a character range in the text according to the movement of the position of the drag operation, an operation to change, in response to the position of the drag operation having moved to a second position at a second relative position relative to the reference position and different from the first relative position, a state of the text displayed on the display, and an operation to set, in response to a predetermined time having elapsed after setting the reference position, the position of the drag operation at the elapse of the predetermined time as the reference position afresh.

According to an aspect of the invention, a text processing method performed by a processor for an electronic device includes setting, in response to a start of a drag operation on a display when displaying a text, a position of the drag operation as a reference position, and performing a first operation. The first operation includes an operation to select, in response to the position of the drag operation having moved to a first position at a first relative position relative to the reference position, a character range in the text according to the movement of the position of the drag operation, and an operation to set, in response to the position of the drag operation having moved to a second position at a second relative position relative to the reference position and different from the first relative position, the second position as the reference position afresh.

According to an aspect of the invention, a text processing method performed by a processor for an electronic device includes setting, in response to a start of a drag operation on a display when displaying a text, a position of the drag operation as a reference position, and performing a first operation. The first operation includes an operation to select, in response to the position of the drag operation having moved to a first position at a first relative position relative to the reference position, a character range in the text according to the movement of the position of the drag operation, an operation to change, in response to the position of the drag operation having moved to a second position at a second relative position relative to the reference position and different from the first relative position, a state of the text displayed on the display, and an operation to set, in response to a predetermined time having elapsed after setting the reference position, the position of the drag operation at the elapse of the predetermined time as the reference position afresh.

According to an aspect of the invention, a non-transitory storage medium stores a computer-readable program. When executed by a processor for an electronic device, the program causes the processor to set, in response to a start of a drag operation on a display when displaying a text, a position of the drag operation as a reference position, and perform a first operation. The first operation includes an operation to select, in response to the position of the drag operation having moved to a first position at a first relative position relative to the reference position, a character range in the text according to the movement of the position of the drag operation, and an operation to set, in response to the position of the drag operation having moved to a second position at a second relative position relative to the reference position and different from the first relative position, the second position as the reference position afresh.

According to an aspect of the invention, a non-transitory storage medium stores a computer-readable program. When executed by a processor for an electronic device, the program causes the processor to set, in response to a start of a drag operation on a display when displaying a text, a position of the drag operation as a reference position, and perform a first operation. The first operation includes an operation to select, in response to the position of the drag operation having moved to a first position at a first relative position relative to the reference position, a character range in the text according to the movement of the position of the drag operation, an operation to change, in response to the position of the drag operation having moved to a second position at a second relative position relative to the reference position and different from the first relative position, a state of the text displayed on the display, and an operation to set, in response to a predetermined time having elapsed after setting the reference position, the position of the drag operation at the elapse of the predetermined time as the reference position afresh.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a front view of an electronic dictionary 10 as an electronic device according to a certain embodiment of the invention, and shows how it may look like.

FIG. 2 is a block diagram of an electronic circuitry configuration of the electronic dictionary 10.

FIG. 3 is a flowchart for explaining text selection and scroll processing (1) performed with the electronic dictionary 10 in a first embodiment.

FIG. 4 is a diagram containing several views to show how text selection is performed according to user operations on an entry word explanatory screen G under the text selection and scroll processing (1) in the first embodiment.

FIG. 5 is a diagram containing enlarged views of respective portions of the views (B), (c), and (D) in FIG. 4.

FIG. 6 is a diagram for explaining a relationship between a second quadrilateral area Q2 and a new second quadrilateral area Q2n, set under the text selection and scroll processing (1) in the first embodiment.

FIG. 7 is a diagram containing several views to show how text display is performed (phase 1) according to user operations on another entry word explanatory screen G under the text selection and scroll processing (1) in the first embodiment.

FIG. 8 is a diagram containing several views to show how text display is performed (phase 2) according to user operations on said another entry word explanatory screen G under the text selection and scroll processing (1) in the first embodiment.

FIG. 9 is a flowchart for explaining text selection and scroll processing (2) performed with the electronic dictionary 10 in a second embodiment.

FIG. 10 is a diagram containing several views to show how text selection is performed according to user operations on an entry word explanatory screen G under the text selection and scroll processing (2) in the second embodiment.

### DETAILED DESCRIPTION

Now, embodiments of the invention will be described with reference to the drawings.

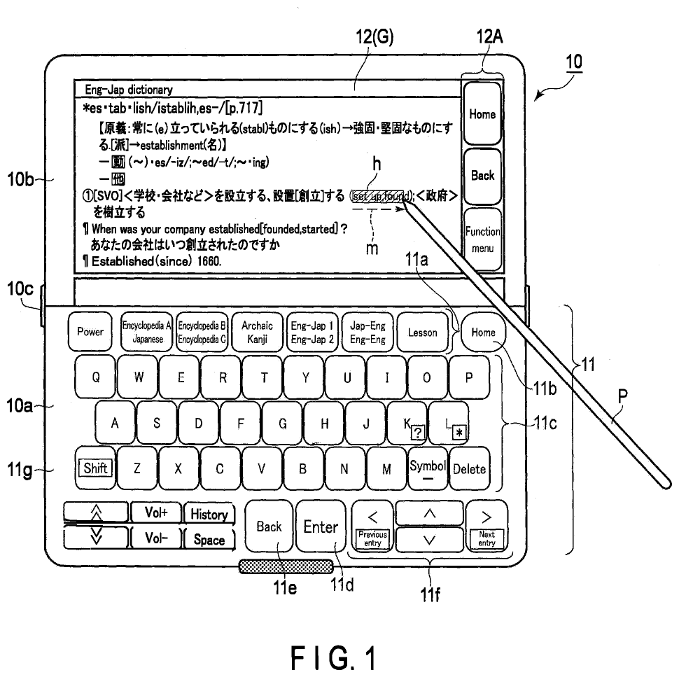

FIG. 1 is a front view of the electronic dictionary 10 as an electronic device according to the embodiments of the invention, and the figure shows its exemplary external design.

Electronic devices according to the embodiments may be implemented in various forms including dedicated electronic dictionaries such as the electronic dictionary 10 as will be described, tablet-type personal digital assistants (PDAs), personal computers (PCs), cellular phones, electronic books, portable game devices, and so on.

The electronic dictionary 10 may be of a foldable case structure constituted by a main case 10a and a cover case 10b coupled via a hinge 10c, so that it can open and close. The main case 10a is furnished with a key input unit (keyboard) 11 in its top surface with the foldable case structure opened, and this key input unit 11 includes function designate keys 11a, a [Home] key 11b, character input keys 11c, an [Enter] key 11d, a [Back] key 11e, cursor keys 11f, a [Shift] key 11g, etc.

Also, the cover case 10b is furnished with a touch panel display 12 in its top surface with the foldable case structure opened. The touch panel display 12 is a combination of a touch position detector adapted to detect user's touch positions given with a stylus pen or a finger, and a display device. The touch panel display 12 is constituted by a transparent touch panel layered over a color liquid-crystal display screen with a back light.

The right end of the touch panel display 12 is a touch key area 12A where key or functional notations (e.g., [Home], [Back], and [Function Menu]) may be provided as fixed printed objects so that actions corresponding to pressing operations with some keys in the key input unit 11 and operations to designate some functions of the electronic dictionary 10 can be performed through touch operations with this area.

The [Home] key 11b in the key input unit 11 is a key to cause the display 12 to display a home screen (not illustrated).

The function designate keys 11a in the key input unit 11 are to directly designate dictionary contents (e.g., [Encyclopedia A]), categories of dictionary contents (e.g., [Japanese], [Archaic], [Kanji], and [English-Japanese]), and categories of learning contents (e.g., [Lesson]), indicated on the respective keys.

One or more keys in the key input unit 11 are adapted so that they can each serve as a key for a boxed function (not a function without a box) indicated on the own key top, upon being operated subsequently to the [Shift] key 11g.

FIG. 1 assumes an instance where the touch panel display 12 is displaying an entry word explanatory screen G giving explanatory information texts corresponding to an entry word (here, a single word “establish”), having been retrieved using an English-Japanese dictionary. Also, FIG. 1 shows that, in this entry word explanatory screen G, a text range selected by a stylus pen P having pointed and moved over a part of text (here, “set up, . . . ”) as shown by an arrow m is highlighted as distinctive display h.

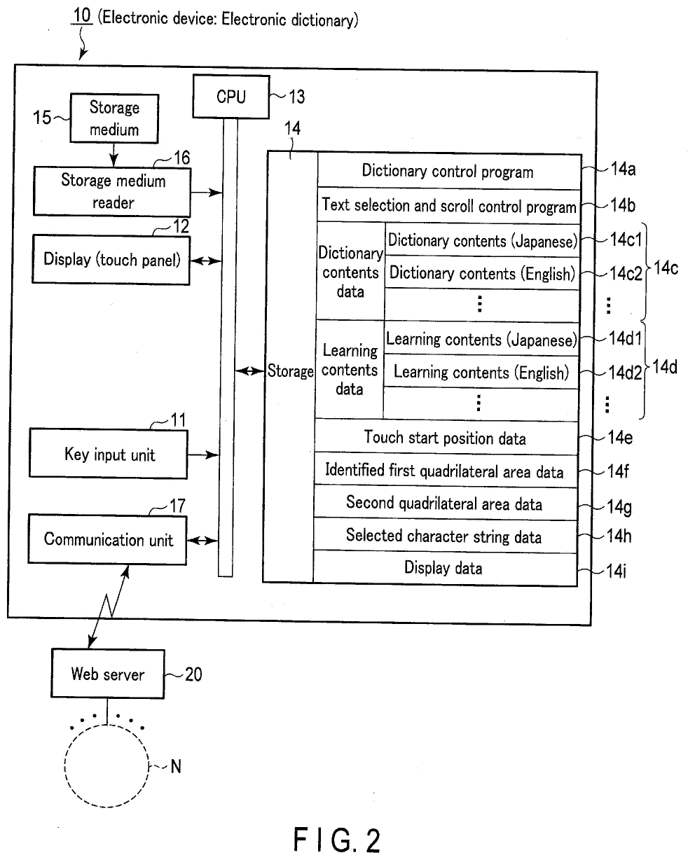

FIG. 2 is a block diagram of an electronic circuitry configuration of the electronic dictionary 10.

The electronic dictionary 10 includes electronic circuitry with a CPU (processor) 13 as a computer. The CPU 13 is adapted to control operations of each circuitry component according to programs including a dictionary control program 14a and a text selection and scroll control program 14b already stored in a storage 14 (which may be a flash ROM, etc.). These programs 14a, 14b, etc. may instead or additionally be read from an external storage medium 15 (which may be a memory card, etc.) by a storage medium reader 16 and stored in the storage 14, or downloaded from a web server 20 (intended to be a program server here) on a communication network N by a communication unit 17 and stored in the storage 14.

The CPU 13 is coupled with the key input unit 11, the touch panel display 12, the storage 14, the storage medium reader 16, the communication unit 17, etc., via a data/control bus.

The storage 14 includes program storage regions (14a, 14b) for storing the dictionary control program 14a and the text selection and scroll control program 14b, as well as a dictionary contents data storage region 14c, a learning contents data storage region 14d, a touch start position storage region 14e, an identified first quadrilateral area data storage region 14f, a second quadrilateral area data storage region 14g, a selected character string data storage region 14h, a display data storage region 14i, and so on.

The dictionary control program 14a may be a set of programs including a system program for controlling the overall operations of the electronic dictionary 10, a program for establishing connections with external electronic devices via the communication unit 17 for communication, and a program for using various data including contents data 14c1, 14c2, . . . and 14d1, 14d2, . . . stored in the respective storage regions 14c and 14d to perform various functions corresponding to the respective contents.

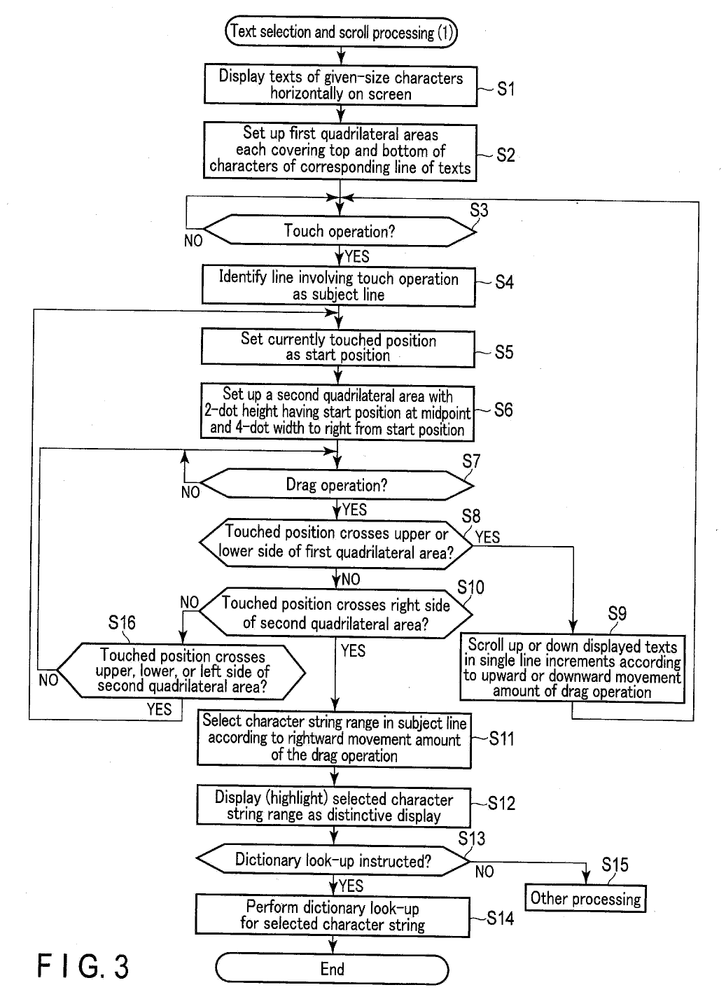

The text selection and scroll control program 14b may be run in conjunction with the dictionary control program 14a, and includes a program for selecting a text range according to user's operations (including touch operations and cursor operations) of specifying positions on the screen G of the touch panel display 12 where texts are displayed, and a program for scrolling display positions of texts (cf. FIG. 3).

The dictionary contents data storage region 14c is for storing dictionary contents data (Japanese language) 14c1, dictionary contents data (English language) 14c2, and so on containing multiple dictionary contents, as applicable contents application data for each dictionary category.

The learning contents data storage region 14d is for storing learning contents data (Japanese language) 14d1, learning contents data (English language) 14d2, and so on containing multiple learning contents, as applicable contents application data for each learning category.

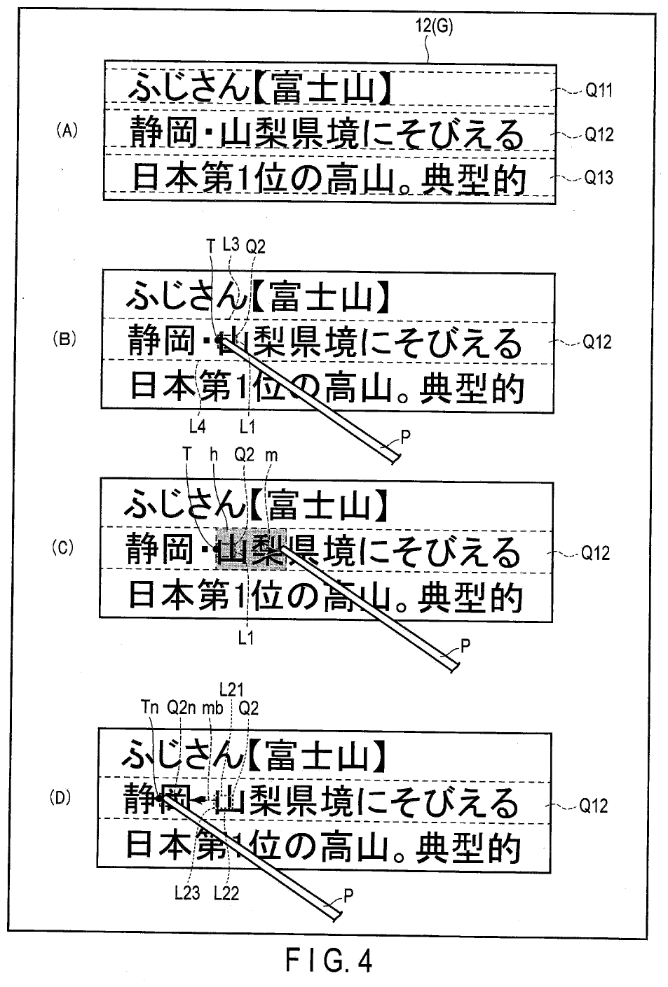

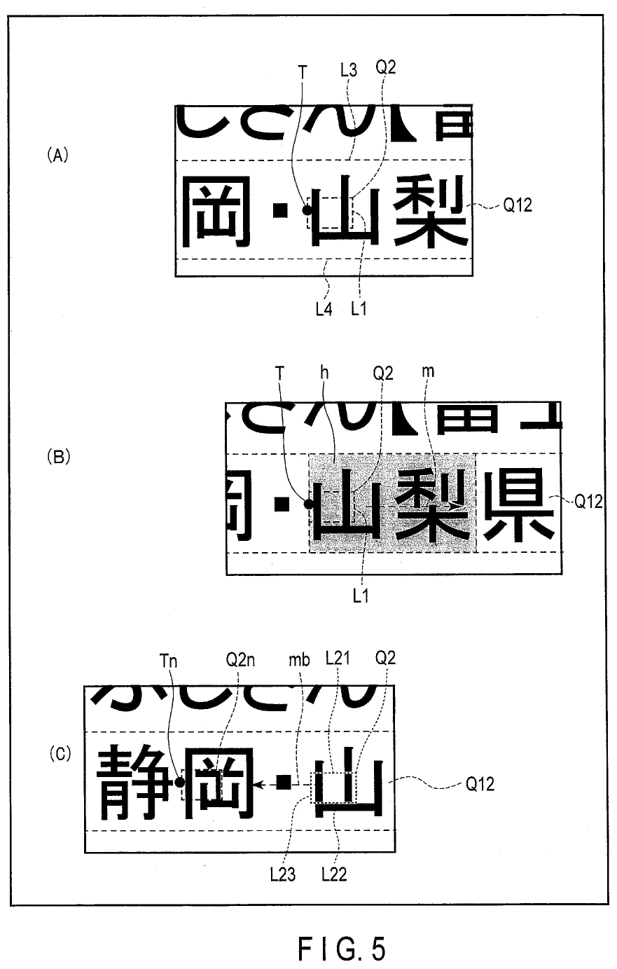

The touch start position storage region 14e is for storing, as a start position T (cf. FIGS. 4 and 5), data about currently specified position on the text-displaying screen G in response to a position-specifying operation according to the text selection and scroll control program 14b.

The identified first quadrilateral area data storage region 14f is for storing data about an identified first quadrilateral area which is, for example, a quadrilateral area Q12 (cf. view (B) in FIG. 4 and view (A) in FIG. 5) identified as an area involving a specified position among the quadrilateral areas Q11, Q12, and Q13 (each may be a first quadrilateral area; cf. view (A) in FIG. 4) set for respective lines as divisional portions of the corresponding text on the screen G, according to the text selection and scroll control program 14b.

The second quadrilateral area data storage region 14g is for storing data about a second quadrilateral area which is, for example, a quadrilateral area Q2 (cf. view (B) in FIG. 4 and view (A) in FIG. 5) set based on the start position T specified on the screen G, with a 2-dot height having the start position T at the midpoint and a 4-dot width to the right from the start position T, according to the text selection and scroll control program 14b.

Note that, for the sake of explanation, the second quadrilateral areas Q2 in views (B) and (C) in FIG. 4 and views (A) and (B) in FIG. 5, as well as new second quadrilateral areas Q2n in view (D) in FIG. 4 and view (C) in FIG. 5 are each shown in a scale that is much exaggerated from the actual size of a 2-dot height and a 4-dot width.

The selected character string data storage region 14h is for storing data about character strings in the range (distinctive display h) selected on the screen G according to the text selection and scroll control program 14b.

The display data storage region 14i is for storing, for example, bitmap-format data of images intended to be displayed on the touch panel display 12 by the CPU 13 according to operations of the electronic dictionary 10.

The electronic dictionary 10 as an electronic device having the foregoing configurations realizes the text selection and scroll functions as will be described, through the cooperative software and hardware actions in which the CPU 13 controls operations of each circuitry component according to the instructions described in the dictionary control program 14a and the text selection and scroll control program 14b.

Next, description will be given of how the electronic dictionary 10 (electronic device) with the above configurations operates.

### First Embodiment

FIG. 3 is a flowchart for explaining the text selection and scroll processing (1) performed with the electronic dictionary 10 in the first embodiment.

FIG. 4 is a diagram showing how the text selection is performed according to user operations on the entry word explanatory screen G under the text selection and scroll processing (1) in the first embodiment.

FIG. 5 is a diagram giving enlarged views of respective portions of the views (B), (c), and (D) in FIG. 4.

For the sake of explanation, FIG. 4 shows only a part of the entry word explanatory screen G displayed on the touch panel display 12.

Also, FIG. 5 omits the stylus pen P shown in FIG. 4, for the sake of explanation.

In one exemplary instance, an entry word search screen (not illustrated) is presented for the dictionary contents data (Japanese language) 14c1 designated in response to an operation on the corresponding function designate key 11a. With this entry word search screen, an entry word “ [symbol] ” as a search target is input by an operation on the character input keys 11c and also on the [Enter] key 11d.

The CPU 13 then retrieves explanatory information texts corresponding to the input entry word “ [symbol] ” from the dictionary contents data (Japanese language) 14c1, and causes the touch panel display 12 to display the texts in the form of the entry word explanatory screen G as shown in view (A) in FIG. 4, where the texts are arranged as horizontal characters in predetermined font sizes (step S1).

The CPU 13 divides the texts presented in the entry word explanatory screen G into portions along the respective lines of character strings such that the top and bottom of the characters are included in the applicable portion, and sets these band-like divisional portions as the first quadrilateral areas Q11, Q12, and Q13, respectively (step S2).

It will be supposed here that the stylus pen P has specified a position of a character “ [symbol] ” included in the first quadrilateral area Q12 as shown in view (B) in FIG. 4 and view (A) in FIG. 5 (step S3, YES). In response to this, the CPU 13 identifies the line corresponding to the first quadrilateral area Q12 involving the specified position, as a subject line for user operations (step S4).

The CPU 13 then sets the currently touched position in the identified subject line (first quadrilateral area Q12) as the start position T (step S5), and sets up the second quadrilateral area Q2 of a certain size at a position predetermined relative to the start position T. The size of this second quadrilateral area Q2, defined by a height (vertical size) and a width (horizontal size), should be smaller than the text font size. For example, when characters are given in a 24×24 dot size and arranged as a horizontal string, the second quadrilateral area Q2 may be set with a 2-dot height having the start position T at the midpoint and a 4-dot width to the right from the start position T so that the second quadrilateral area Q2 is longer in the direction along the character string (step S6). While the description will assume the cases of using such a second quadrilateral area Q2, the embodiments do not limit the position, size, etc. of the second quadrilateral area Q2 to what have been mentioned. Particulars of the second quadrilateral area Q2 may be discretionarily determined according to a size of the character or character string, horizontal or vertical arrangement of characters, manner of user operations, and so on. For example, the second quadrilateral area Q2 may be set so that the start position T is located at its center, or that it has a square shape or a vertically long rectangular shape. Also, the position, size, etc. of the second quadrilateral area Q2 may be adjusted according to user operations.

When the position specified by the stylus pen P is moved from the start position T, the CPU 13 determines that a drag operation is performed (step S7, YES). If it is determined that the specified position moved by this drag operation crosses over an upper side L3 (third boundary) or a lower side L4 (fourth boundary) of the first quadrilateral area Q12 identified in step S4 (step S8, YES), the CPU 13 causes the display of the explanatory information texts on the entry word explanatory screen G to scroll up or down in single line increments according to the amount of the upward or downward movement of the specified position (step S9).

In the case of NO in step S8, if it is determined that the specified position moved by the drag operation from the start position T crosses over a right side L1 (first boundary) of the second quadrilateral area Q2 set in step S6 in response to its rightward movement as shown by, for example, the dashed arrow m in each of view (C) in FIG. 4 and view (B) in FIG. 5 (step S10, YES), the CPU 13 selects the range of character string in the subject line corresponding to the first quadrilateral area Q12 identified in step S4, according to the amount of the rightward movement by the drag operation (step S11). The CPU 13 highlights the selected range of character string (here, “ [symbol] ”) as the distinctive display h (step S12).

If it is determined here that dictionary look-up (dictionary search) is instructed through, for example, an operation on the [Enter] key 11d (step S13, YES), the CPU 13 searches the dictionary contents data (Japanese language) 14c1 for the selected character string “ [symbol] ” (in distinctive display h) as a search target entry word, and causes the touch panel display 12 to display the entry word explanatory screen G for the selected character string (entry word) “ [symbol] ” (step S14).

Note that the processing flow from step S11 to step S13 may proceed as follows. That is, for example, during the ongoing drag operation, the selected range of character string may be sequentially enlarged in conjunction with the drag operation, and the characters in the range may be simultaneously highlighted as the distinctive display h just upon the selection. Then, when the touch operation is stopped by separation of the stylus pen P, etc., which may be regarded as the timing of termination of the drag operation, the CPU 13 may determine that the dictionary look-up (dictionary search) is instructed.

If it is determined in step S13 that a function other than the dictionary look-up (dictionary search) is instructed (step S13, NO), the CPU 13 performs processing corresponding to the instructed function for the selected character string “ [symbol] ” (in distinctive display h), such as one or combination of marker processing for adding a marker of a desired color, voice processing for outputting a voice corresponding to the selected character string, display processing for displaying idioms, example sentences, etc. (different from information from normal dictionary look-up) for the selected character string, and so on (step S15).

In the case of NO in step S10, if it is determined that the specified position moved by the drag operation from the start position T crosses over one of an upper side L21, a lower side L22, and a left side L23 (second boundary; here, the left side L23) of the second quadrilateral area Q2 set in step S6 in response to its upward, downward, or leftward movement (here, leftward movement) as shown by, for example, the dashed arrow mb in each of view (D) in FIG. 4 and view (C) in FIG. 5 (step S16, YES), the CPU 13 resets the currently touched position to be the new start position Tn (step S5), and sets up the new second quadrilateral area Q2n with a 2-dot height having this new start position Tn at the midpoint and a 4-dot width to the right from the new start position Tn (step S6).

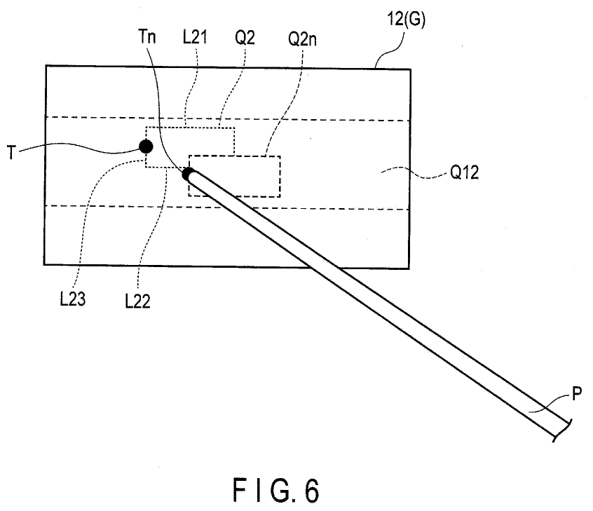

FIG. 6 is a diagram for explaining the relationship between the second quadrilateral area Q2 and the new second quadrilateral area Q2n, set under the text selection and scroll processing (1) in the first embodiment.

What have been shown in view (D) in FIG. 4 and view (C) in FIG. 5 are the new start position Tn and the new second quadrilateral area Q2n which are created (set afresh) as a result of the specified position having been largely moved by the drag operation from the start position T, beyond one of the upper, lower, and left sides (here, the left side L23) of the second quadrilateral area Q2. In practice, however, the new start position Tn and the new second quadrilateral area Q2n may be repeatedly set; namely, as shown in FIG. 6, they may be set every time the specified position moved by the drag operation from the last start position T crosses over one of the upper, lower, and left sides (here, the lower side L22) of the last second quadrilateral area Q2. As such, the example case concerned by view (D) in FIG. 4 and view (C) in FIG. 5 may be understood as implying that, after setting up the illustrated second quadrilateral area Q2 relative to the start position T, and until setting up the illustrated new second quadrilateral area Q2n relative to the new start point Tn, a different new second quadrilateral area Q2n is repeatedly and overlappedly set every time the specified position moved by the drag operation crosses over the left side L23 of the last second quadrilateral area Q2.

The CPU 13 then goes over the steps from step S7 in a similar manner, based on the freshly set new start position Tn and new second quadrilateral area Q2n to thereby perform, according to the movement of the specified position on the entry word explanatory screen G, one of the text display scroll processing (steps S7 to S9), the character string range select processing (steps S7, S10 to S12), and the reset processing for setting further new start position Tn and new second quadrilateral area Q2n (steps S7, S16→S5, S6).

With the foregoing configurations and operations, the embodiment can, for example, eliminate the inconvenience of an undesired character string being selected. Such inconvenience could occur when a user accidentally specifies, on the screen G, an initial position with a rightward deviation from the first character of the desired text, and the user subsequently returns the specified position to the desired first character on the left, whereby the range of the character string from a character on the deviated position to the character on the returned position is unintentionally selected. Moreover, the embodiment allows the user to easily specify afresh the position for a desired text, without requiring particular operations such as cancellation of the currently specified position, etc.

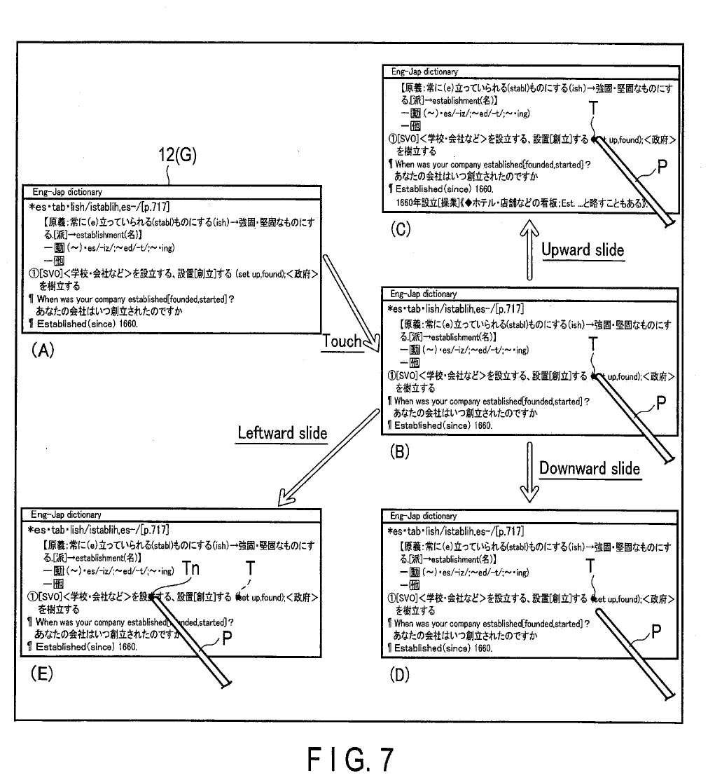

FIG. 7 is a diagram showing how the text display is performed (phase 1) according to user operations on another exemplary entry word explanatory screen G under the text selection and scroll processing (1) in the first embodiment.

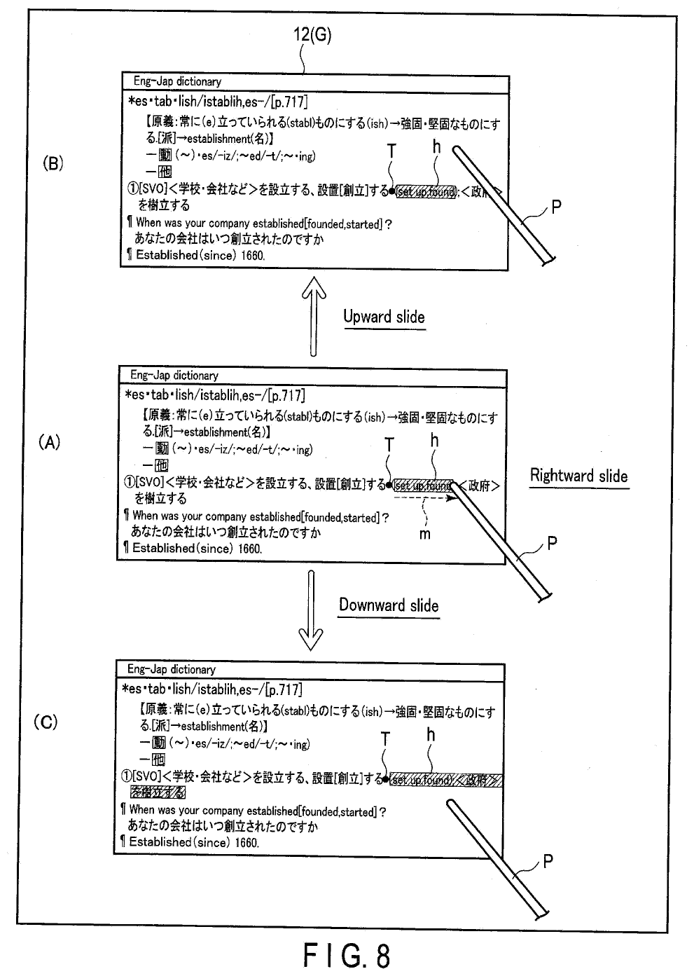

FIG. 8 is a diagram showing how the text display is performed (phase 2) according to user operations on said another entry word explanatory screen G under the text selection and scroll processing (1) in the first embodiment.

Note that FIGS. 7 and 8 each show the entirety of the entry word explanatory screen G to be displayed on the touch panel display 12, where texts are given in smaller size in relation to the figure size. Thus, FIGS. 7 and 8 omit the first quadrilateral areas Q11, Q12, . . . , and the second quadrilateral area Q2, which are shown in FIGS. 4 and 5. However, the example cases concerned by FIGS. 7 and 8 involve the processing of setting the start position T, the first quadrilateral areas Q11, Q12, . . . , and the second quadrilateral area Q2, the processing of selecting a text, and the processing of scrolling display, as well.

It will be supposed that, in the entry word explanatory screen G for the entry word “establish” as shown in view (A) in FIG. 7, the stylus pen P specifies the position of the first character “s” of the English phrase “set up” appearing in the character string at line 6, as shown in view (B) in FIG. 7. It will also be supposed that the specified position is then moved upward (or downward) as shown in view (C) in FIG. 7 (or view (D) in FIG. 7). Upon these actions, the text display on the entry word explanatory screen G is scrolled up (or down) according to the amount of the upward (or downward) movement of the specified position (steps S1 to S9).

Here, the entry word explanatory screen G shown in view (B) in FIG. 7 already covers the first line of the explanatory information text for the entry word “establish”, and as such, the downward movement of the specified position by the stylus pen P does not cause the scrolling of the text display as shown in view (D) in FIG. 7.

When the position of the first character “s” of the English phrase “set up” in the character string at line 6 is specified by the stylus pen P as shown in view (B) in FIG. 7, and if the specified position is moved rightward as indicated by the dashed arrow m in view (A) in FIG. 8, the character string according to the amount of the rightward movement of the specified position, namely, the character string “set up, . . . ”, is selected, and this selected range of character string is highlighted as distinctive display h (steps S7, S10 to S12).

Note that, in the state where the character string “set up, . . . ” according to the amount of the rightward movement of the specified position has been selected and placed in the distinctive display h as shown in view (A) in FIG. 8, the upward movement of the specified position does not cause the scrolling of the text display, and the range (distinctive display h) of the selected character string “set up, . . . ” is maintained, as shown in view (B) in FIG. 8.

Also, in the state where the character string “set up, . . . ” according to the amount of the rightward movement of the specified position has been selected and placed in the distinctive display h as shown in view (A) in FIG. 8, the downward movement of the specified position does not cause the scrolling of the text display, and the range (distinctive display h) of the selected character string “set up, . . . ” is extended according to the amount of this downward movement of the specified position, as shown in view (C) in FIG. 8.

If, on the other hand, after the position of the first character “s” of the English phrase “set up” in the character string at line 6 is specified by the stylus pen P as shown in view (B) in FIG. 7, the specified position is moved leftward as shown in view (E) in FIG. 7, the resulting currently touched position is set as the new start position Tn, and the new second quadrilateral area Q2n is also set afresh relative to this new start position Tn (steps S7, S16→S5). Thus, the user is enabled to easily specify afresh the position for a desired text, without performing particular operations such as cancellation of the currently specified position, etc.

Under the text selection and scroll functions according to the first embodiment as realized by the electronic dictionary 10 (electronic device) with the configurations described above, in response to a user operation specifying a position on the screen G where texts are presented horizontally, the first quadrilateral area (Q12 in the discussed examples) corresponding to the line involving the specified position is identified as a subject line for user operations. Together, the currently specified position is set as the start position T, and relative to this start position T, the second quadrilateral area Q2 is set up with a shape that may be a rectangle longer in the character arrangement direction, i.e., the right, and with a small size that may account for, e.g., ⅓ or less of a character size.

Then, in response to the specified position having moved across the upper side or the lower side of the identified first quadrilateral area Q12 due to a user operation, the text display is scrolled up or down according to the amount of this movement of the specified position. Also, in response to the specified position having moved rightward across the right side of the second quadrilateral area Q2, a range of character string in the identified first quadrilateral area Q12 is selected according to the amount of the rightward movement of the specified position. If, on the other hand, the specified position is moved across one of the upper side, the lower side, and the left side of the second quadrilateral area Q2, the new start position Tn and the new second quadrilateral area Q2n are set afresh, so that the state of movement of the specified position will be determined afresh. Accordingly, the user can easily specify the position for a desired text afresh, without a need of performing particular operations such as cancellation of the currently specified position, etc.

Consequently, the user is allowed to select its desired text range on the text-displaying screen, while enjoying an enhanced operability realized by the embodiment.

### Second Embodiment

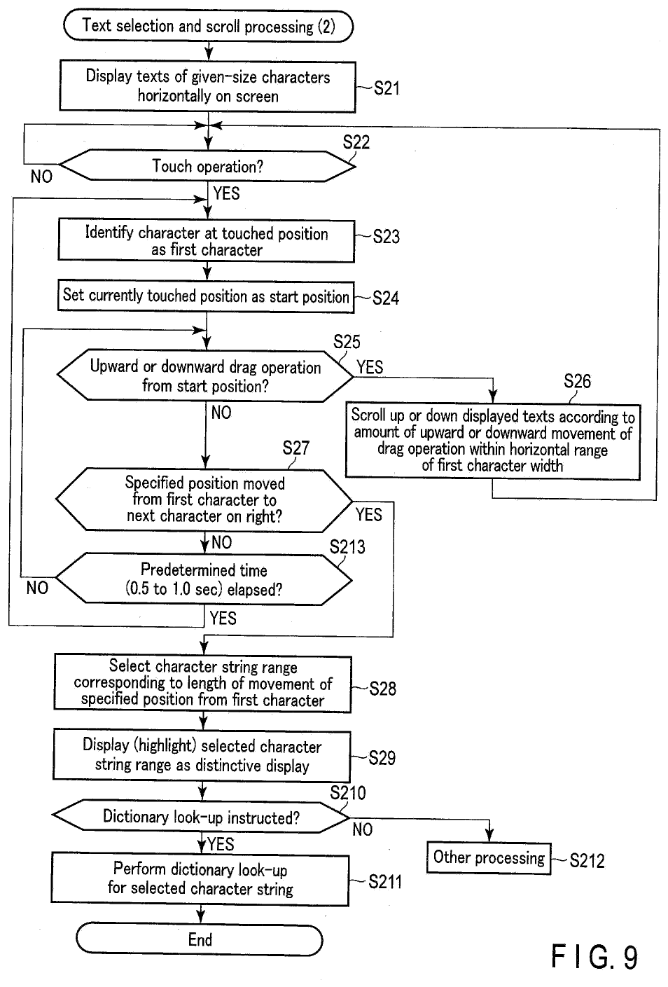

FIG. 9 is a flowchart for explaining the text selection and scroll processing (2) performed with the electronic dictionary 10 in the second embodiment.

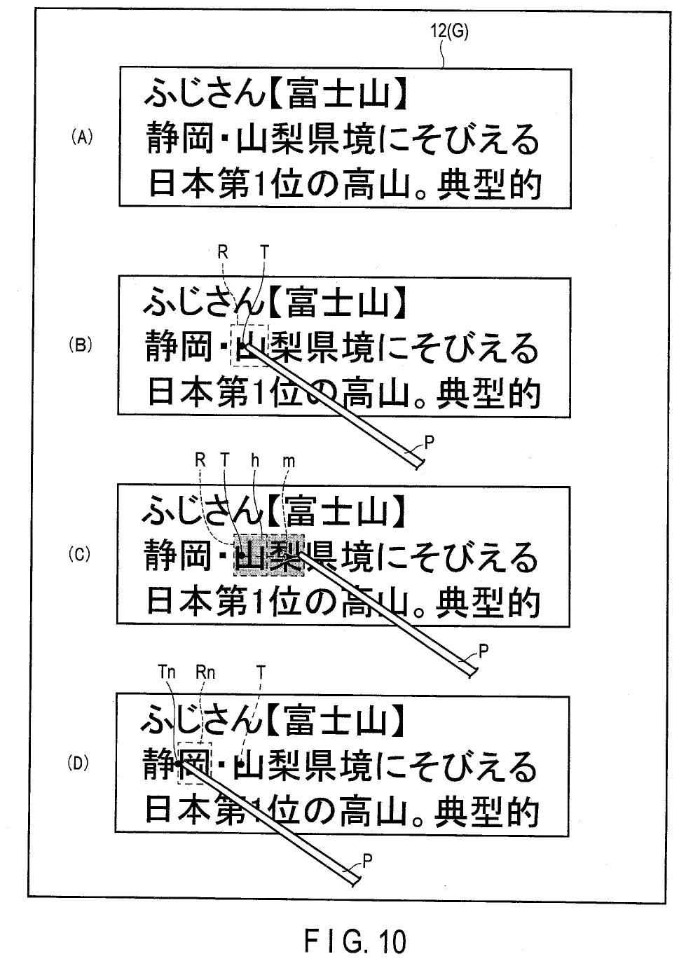

FIG. 10 is a diagram showing how the text selection is performed according to user operations on the entry word explanatory screen G under the text selection and scroll processing (2) in the second embodiment.

For the sake of explanation, FIG. 10 shows only a part of the entry word explanatory screen G displayed on the touch panel display 12, in a manner similar to FIG. 4.

In the exemplary instance shown, the CPU 13 retrieves explanatory information texts corresponding to the entry word “ [symbol] ” input according to a user operation, from the dictionary contents data (Japanese language) 14c1, and causes the touch panel display 12 to display the texts in the form of the entry word explanatory screen G as shown in view (A) in FIG. 10, where the texts are arranged as horizontal characters in predetermined font sizes (step S21).

Suppose that the stylus pen P has specified a position of a character “ [symbol] ” on the entry word explanatory screen G as shown in view (B) in FIG. 10 (step S22, YES). In response to this, the CPU 13 identifies the character “ [symbol] ” at the specified position as a first character R (step S23), and sets the currently touched position as the start position T (step S24).

Then, when the CPU 13 determines that a drag operation is performed in response to the position specified by the stylus pen P having moved upward or downward from the start position T (step S25, YES), the CPU 13 causes the display of the explanatory information texts on the entry word explanatory screen G to scroll up or down in single line increments, according to the amount of the upward or downward movement of the specified position within the horizontal range corresponding to the width of the first character R (here, “ [symbol] ”) (step S26).

In the case of NO in step S25, if it is determined that the specified position is moved by the drag operation from the start position T to the position of the character “ [symbol] ” on the immediate right side of the first character R (here, “ [symbol] ”) in response to its rightward movement as shown by, for example, the dashed arrow m in view (C) in FIG. 10 (step S27, YES), the CPU 13 selects the range of character string corresponding to the length of movement of the specified position from the first character R (“ [symbol] ”) identified in step S23 (step S28). The CPU 13 highlights the selected range of character string (here, “ [symbol] ”) as distinctive display h (step S29).

If it is determined here that dictionary look-up (dictionary search) is instructed through, for example, an operation on the [Enter] key 11d (step S210, YES), the CPU 13 searches the dictionary contents data (Japanese language) 14c1 for the selected character string “ [symbol] ” (in distinctive display h) as a search target entry word, and causes the touch panel display 12 to display the entry word explanatory screen G for the selected character string (entry word) “ [symbol] ” (step S211).

If it is determined in step S210 that a function other than the dictionary look-up (dictionary search) is instructed (step S210, NO), the CPU 13 performs processing corresponding to the instructed function for the selected character string “ [symbol] ” (in distinctive display h), such as retrieval processing with a Japanese-English dictionary (step S212).

Suppose the case where the CPU 13 neither determines that a drag operation is performed for the upward or downward movement of the position specified by the stylus pen P from the start position T (step S25, NO), nor determines that the specified position is moved to the position of the character “ [symbol] ” on the right side of the first character R (here, “ [symbol] ”) (step S27, NO). In this case, if, after setting the start position T, it is determined that a predetermined time (e.g., 0.5 to 1.0 sec) has elapsed while the specified position is away from the first character R (“ [symbol] ”) to the left, i.e., in the direction of the word “ [symbol] ”, according to a user operation as shown in, for example, view (D) in FIG. 10 (step S213, YES), the CPU 13 identifies afresh the character “ [symbol] ” at the currently specified position as the new first character Rn (step S32), and sets afresh the currently touched position as the new start position Tn (step S24).

The CPU 13 then goes over the steps from step S25 in a similar manner, based on the freshly identified new first character Rn and the freshly set new start position Tn to thereby perform, according to the movement of the specified position on the entry word explanatory screen G, one of the text display scroll processing (steps S25, S26), the character string range select processing (steps S27 to S29), and the reset processing for further new first character Rn and new start position Tn (steps S13→S23, S24).

As above, the text selection and scroll processing (2) of the second embodiment is as advantageous as the text selection and scroll processing (1) of the first embodiment. For example, it can eliminate the inconvenience of an undesired character string being selected. This inconvenience could occur when a user accidentally specifies, on the screen G, an initial position with a rightward deviation from the first character of the desired text, and the user subsequently returns the specified position to the desired first character on the left, whereby the range of the character string from a character on the deviated position to the character on the returned position is unintentionally selected. Moreover, the second embodiment also allows the user to easily specify afresh the position for a desired text, without requiring particular operations such as cancellation of the currently specified position, etc. Consequently, the user is allowed to select the desired text range on the text-displaying screen, while enjoying an enhanced operability realized by the embodiment.

Note that the operations (phase 1) illustrated by FIG. 7 and the operations (phase 2) illustrated by FIG. 8, using one exemplary entry word explanatory screen G for displaying texts according to user operations, can be likewise implemented under the text selection and scroll processing (2) of the second embodiment.

While the foregoing description of the embodiments has assumed that the character string to be selected on the screen G of the touch panel display 12 includes a symbol-type character such as “⋅” or “∘”, the embodiments may adopt a configuration to, for example, limit a selectable character type according to an operational mode designated by a user.

Also, the foregoing description of the embodiments has assumed the text selection and scroll processing for the screen G of the touch panel display 12, where texts are presented in horizontal arrangement. As a matter of course, the text selection and scroll processing of each embodiment is applicable also to the cases where texts are given in vertical arrangement or other arrangement, by suitably adjusting the direction of setting the first quadrilateral areas Q11, Q12, . . . , and the second quadrilateral area Q2, and the direction referenced in determining the movement of the specified position, in accordance with the employed character string arrangement.

The foregoing description of the embodiments has assumed the use of the stylus pen P for a user to specify positions on the screen G where texts are displayed. As a matter of course, the text selection and scroll processing of each embodiment can be likewise performed when the positions are specified instead by the user's own finger or a pointer controllably displayed on the screen G.

Processing intended for implementation through the electronic dictionary 10 (electronic device) as described for the foregoing embodiments, such as the text selection and scroll processing (1) of the first embodiment shown in the flowchart of FIG. 3 and the text selection and scroll processing (2) of the second embodiment shown in the flowchart of FIG. 9, may each or in combination be stored and distributed in the form of a computer-executable program in an external storage medium, e.g., a memory card (ROM card, RAM card), a magnetic disk (Floppy™ disk, hard disk), an optical disk (CD-ROM, DVD), or a semiconductor memory. A computer (CPU) in an electronic device with a display function may load this program stored in the external storage medium into its own storage unit, and control the device operations according to the program, so that the text selection and scroll functions as discussed for each embodiment will be performed to realize the processing corresponding to the processing in each embodiment.

The program data for realizing the respective processing may be transmitted on the communication network N in the form of program codes. The program data may be given from a computer device (program server) having connection to the communication network N, and imported into the storage unit of an individual electronic device with a display function, so that the text selection and scroll functions as discussed for each embodiment will be performed to realize the processing corresponding to the processing in each embodiment.

Note that the present invention is not limited to the above embodiments as they are. For practical implementation, the invention can adopt various modifications without departing from the gist of the invention. Moreover, the foregoing embodiments involve various aspects, and appropriate combinations of the features disclosed herein shall permit various inventions to be derived. For example, one or more of the features disclosed in each embodiment may be omitted, replaced with different features, or combined in a different manner. Provided that such modifications can solve the intended problem and bring the intended effects as discussed above, the modifications should each be deemed an invention.

In one example that may be derived as an invention, the processor for the electronic device according to a certain embodiment may be adapted so that it sets, in response to a start of a drag operation on a display where a text is displayed, a position of the drag operation as a reference position for processing for the displayed text, and then performs a first operation. The first operation includes an operation to select, in response to the position of the drag operation having moved to a first position at a first relative position relative to the reference position, a character range in the text according to the movement of the position of the drag operation. The first operation also includes an operation to set, in response to the position of the drag operation having moved to a second position at a second relative position relative to the reference position and different from the first relative position, this second position as the reference position afresh. The processor may repeat the first operation based on the reference position set afresh, until termination of the drag operation.

Also, in this example, the processor may be adapted to perform the first operation further including an operation to set up a criterion area defined by a first boundary on the first relative position relative to the reference position and a second boundary on the second relative position relative to the reference position, and an operation to determine whether the position of the drag operation has moved and crossed one of the first boundary and the second boundary. Then, in response to determining that the position of the drag operation has moved and crossed the first boundary, the processor selects a character range in the text according to the movement of the position of the drag operation on the display, and in response to determining that the position of the drag operation has moved and crossed the second boundary, the processor sets the position of the drag operation at the determination of crossing the second boundary as the reference position afresh.

Moreover, the processor may be adapted so that it performs, after setting the reference position, the first operation and a second operation. The second operation includes an operation to change, in response to the position of the drag operation having moved to a third position at a third relative position relative to the text, a state of the text displayed on the display according to the movement of the position of the drag operation on the display.

In a further example that may be derived as an invention, the processor for the electronic device according to a certain embodiment may be adapted so that it sets, in response to a start of a drag operation on a display where a text is displayed, a position of the drag operation as a reference position, and then performs a first operation. The first operation includes an operation to select, in response to the position of the drag operation having moved to a first position at a first relative position relative to the reference position, a character range in the text according to the movement of the position of the drag operation. The first operation also includes an operation to change, in response to the position of the drag operation having moved to a second position at a second relative position relative to the reference position and different from the first relative position, a state of the text displayed on the display. The first operation further includes an operation to set, in response to a predetermined time having elapsed after setting the reference position, the position of the drag operation at the elapse of the predetermined time as the reference position afresh. The processor may repeat the first operation based on the reference position set afresh, until termination of the drag operation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic device comprising:
a display; and
a processor,
wherein the processor is configured to set, in response to a start of a drag operation on the display when displaying a text, a position of the drag operation as a reference position for processing for the text, and to perform a first operation,
the first operation comprising
an operation to select, in response to the position of the drag operation having moved to a first position at a first relative position relative to the reference position, a character range in the text according to the movement of the position of the drag operation, and
an operation to set, in response to the position of the drag operation having moved to a second position at a second relative position relative to the reference position and different from the first relative position, the second position as the reference position afresh.

2. The electronic device according to claim 1, wherein the processor is configured to repeat, until termination of the drag operation, the first operation using the reference position set afresh.

3. The electronic device according to claim 1, wherein the first operation comprises
an operation to set up a criterion area defined by a first boundary on the first relative position relative to the reference position and a second boundary on the second relative position relative to the reference position,
an operation to determine whether the position of the drag operation has moved and crossed one of the first boundary and the second boundary,
an operation to select, in response to determining that the position of the drag operation has moved and crossed the first boundary, a character range in the text according to the movement of the position of the drag operation on the display, and
an operation to set, in response to determining that the position of the drag operation has moved and crossed the second boundary, the position of the drag operation at the determination of crossing the second boundary as the reference position afresh.

4. The electronic device according to claim 3, wherein the processor is configured to perform, after setting the reference position, the first operation and a second operation,
the second operation comprising an operation to change, in response to the position of the drag operation having moved to a third position at a third relative position relative to the text, a state of the text displayed on the display according to the movement of the position of the drag operation on the display.

5. The electronic device according to claim 4, wherein the second operation comprises
an operation to set up a criterion area defined by a third boundary on the third relative position relative to the text and a fourth boundary on a fourth relative position relative to the text and different from the third relative position,
an operation to determine whether the position of the drag operation has moved and crossed one of the third boundary and the fourth boundary,
an operation to move, in response to determining that the position of the drag operation has moved and crossed the third boundary, the text displayed on the display in a first direction according to the movement of the position of the drag operation on the display, and
an operation to move, in response to determining that the position of the drag operation has moved and crossed the fourth boundary, the text displayed on the display in a second direction different from the first direction according to the movement of the position of the drag operation on the display.

6. The electronic device according to claim 3, wherein the first operation comprises
an operation to set up, as the criterion area, a quadrilateral area having a first side conforming to the first boundary and a second side conforming to the second boundary,
an operation to determine whether the position of the drag operation has moved and crossed one of the first side and the second side,
an operation to select, in response to determining that the position of the drag operation has moved and crossed the first side, a character range in the text according to the movement of the position of the drag operation on the display, and
an operation to set, in response to determining that the position of the drag operation has moved and crossed the second side, the position of the drag operation at the determination of crossing the second side as the reference position afresh, to set up the quadrilateral area afresh with the first side conforming to a first boundary on the first relative position relative to the reference position set afresh and the second side conforming to a second boundary on the second relative position relative to the reference position set afresh, and to make a determination for a movement of the position of the drag operation based on the quadrilateral area set afresh.

7. The electronic device according to claim 3, wherein the first operation comprises
an operation to set up, as the criterion area, a rectangular area that is longer in a direction in which the text is arranged, and has a major portion in the direction in which the text is arranged with respect to the reference position.

8. The electronic device according to claim 5, wherein
the text comprises characters arranged rightward with respect to the display,
the first boundary is rightward away from the reference position by a first distance,
the second boundary is vertically away from the reference position by a second distance, or on the reference position,
the third boundary and the fourth boundary are above and below the text respectively, and away from each other by a third distance greater than the second distance,
the character range selected in the text is a string of characters comprising the characters arranged rightward with respect to the display, and
the operation to change the state of the text comprises vertically scrolling the text on the display.

9. The electronic device according to claim 1, wherein
the display is configured as a touch panel display to display the text, and
a position on the display is specified by a touch operation.

10. An electronic device comprising:
a display; and
a processor,
wherein the processor is configured to set, in response to a start of a drag operation on the display when displaying a text, a position of the drag operation as a reference position, and to perform a first operation,
the first operation comprising
an operation to select, in response to the position of the drag operation having moved to a first position at a first relative position relative to the reference position, a character range in the text according to the movement of the position of the drag operation,
an operation to change, in response to the position of the drag operation having moved to a second position at a second relative position relative to the reference position and different from the first relative position, a state of the text displayed on the display, and
an operation to set, in response to a predetermined time having elapsed after setting the reference position, the position of the drag operation at the elapse of the predetermined time as the reference position afresh.

11. The electronic device according to claim 10,
wherein the processor is configured to repeat, until termination of the drag operation, the first operation using the reference position set afresh.

12. A text processing method performed by a processor for an electronic device, the method comprising:
setting, in response to a start of a drag operation on a display when displaying a text, a position of the drag operation as a reference position, and
performing a first operation, wherein the first operation comprises
an operation to select, in response to the position of the drag operation having moved to a first position at a first relative position relative to the reference position, a character range in the text according to the movement of the position of the drag operation, and
an operation to set, in response to the position of the drag operation having moved to a second position at a second relative position relative to the reference position and different from the first relative position, the second position as the reference position afresh.

13. The text processing method according to claim 12, further comprising
repeating, until termination of the drag operation, the first operation using the reference position set afresh.

14. A text processing method performed by a processor for an electronic device, the method comprising:
setting, in response to a start of a drag operation on a display when displaying a text, a position of the drag operation as a reference position, and
performing a first operation, wherein the first operation comprises
an operation to select, in response to the position of the drag operation having moved to a first position at a first relative position relative to the reference position, a character range in the text according to the movement of the position of the drag operation,
an operation to change, in response to the position of the drag operation having moved to a second position at a second relative position relative to the reference position and different from the first relative position, a state of the text displayed on the display, and
an operation to set, in response to a predetermined time having elapsed after setting the reference position, the position of the drag operation at the elapse of the predetermined time as the reference position afresh.

15. The text processing method according to claim 14, further comprising
repeating, until termination of the drag operation, the first operation using the reference position set afresh.

16. A non-transitory storage medium storing a computer-readable program which when executed by a processor for an electronic device causes the processor to:
set, in response to a start of a drag operation on a display when displaying a text, a position of the drag operation as a reference position; and
perform a first operation, wherein the first operation comprises
an operation to select, in response to the position of the drag operation having moved to a first position at a first relative position relative to the reference position, a character range in the text according to the movement of the position of the drag operation, and
an operation to set, in response to the position of the drag operation having moved to a second position at a second relative position relative to the reference position and different from the first relative position, the second position as the reference position afresh.

17. The non-transitory storage medium according to claim 16,
wherein the program when executed by the processor causes the processor to repeat, until termination of the drag operation, the first operation using the reference position set afresh.

18. A non-transitory storage medium storing a computer-readable program which when executed by a processor for an electronic device causes the processor to:
set, in response to a start of a drag operation on a display when displaying a text, a position of the drag operation as a reference position; and
perform a first operation, wherein the first operation comprises
an operation to select, in response to the position of the drag operation having moved to a first position at a first relative position relative to the reference position, a character range in the text according to the movement of the position of the drag operation,
an operation to change, in response to the position of the drag operation having moved to a second position at a second relative position relative to the reference position and different from the first relative position, a state of the text displayed on the display, and
an operation to set, in response to a predetermined time having elapsed after setting the reference position, the position of the drag operation at the elapse of the predetermined time as the reference position afresh.

19. The non-transitory storage medium according to claim 18,
wherein the program when executed by the processor causes the processor to repeat, until termination of the drag operation, the first operation using the reference position set afresh.
